(19) United States
(12) Patent Application Publication
(10) Pub. No.: US 2009/0153706 A1
(43) Pub. Date: Jun. 18, 2009

(54) IMAGING MODULE PACKAGE

(75) Inventors: STEVEN WEBSTER, Tu-Cheng (TW); YING-CHENG WU, Tu-Cheng (TW); SHUO-WEI HUANG, Tu-Cheng (TW); SHIH-MIN LO, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/100,297

(22) Filed: Apr. 9, 2008

(30) Foreign Application Priority Data
Dec. 18, 2007 (CN) 200710203169.7

(51) Int. Cl. H04N 5/335

(52) U.S. Cl. 348/294; 348/E05.091

(57) ABSTRACT

An imaging module package includes a substrate, an imaging sensor chip, a functional unit, a housing, and a lens module positioned in the housing. The substrate defines an upper chamber extending through a top surface thereof, and a lower chamber extending through a bottom surface thereof. The imaging sensor chip is positioned in the upper chamber and is electrically connected to the substrate. The functional unit is positioned in the lower chamber and is electrically connected to the substrate. The housing is mounted on the top surface of the substrate and is disposed above the imaging sensor chip.

### BACKGROUND

1. Technical Field

The present invention relates to imaging technology and, particularly, to an imaging module package integrated with multiple functional units and having a compact configuration.

2. Description of Related Art

Many electronic devices, such as mobile phones, notebooks, or personal digital assistants etc, are integrated with imaging module packages. An imaging module package generally comprises a substrate, an imaging sensor chip mounted to the substrate, a lens module, and a housing mounted to the substrate for housing the imaging sensor chip and the lens module. It is well-known that the imaging module package must be coupled to functional units, such as processing units, controlling units, or memory units etc, which can process or store images. Thus, the electronic device must be equipped with the imaging module package as well as these units for supporting an imaging function thereof.

What is needed, therefore, is an imaging module package integrated with multiple functions and having a compact configuration.

### SUMMARY

In accordance with a present embodiment, an imaging module package includes a substrate, an imaging sensor chip, a functional unit, a housing, and a lens module positioned in the housing. The substrate defines an upper chamber extending through a top surface thereof, and a lower chamber extending through a bottom surface thereof. The imaging sensor chip is positioned in the upper chamber and is electrically connected to the substrate. The functional unit is positioned in the lower chamber and is electrically connected to the substrate. The housing is mounted on the top surface of the substrate and is disposed above the imaging sensor chip.

Other advantages and novel features will be drawn from the following detailed description of at least one preferred embodiment, when considered in conjunction with the attached drawings.

### BRIEF DESCRIPTION OF THE DRAWINGS

Many aspects of the present imaging module package can be better understood with reference to the following drawings. The components in the drawings are not necessarily drawn to scale, the emphasis instead being placed upon clearly illustrating the principles of the present imaging module package. Moreover, in the drawings, like reference numerals designate corresponding parts throughout the several views.

FIG. 1 is a schematic, cross-sectional view of an imaging module package, according to a present first embodiment.

FIG. 2 is a schematic, cross-sectional view of an imaging module package, according to a present second embodiment.

### DETAILED DESCRIPTION OF THE EMBODIMENTS

Embodiments of the present imaging module package will now be described in detail below and with reference to the drawings.

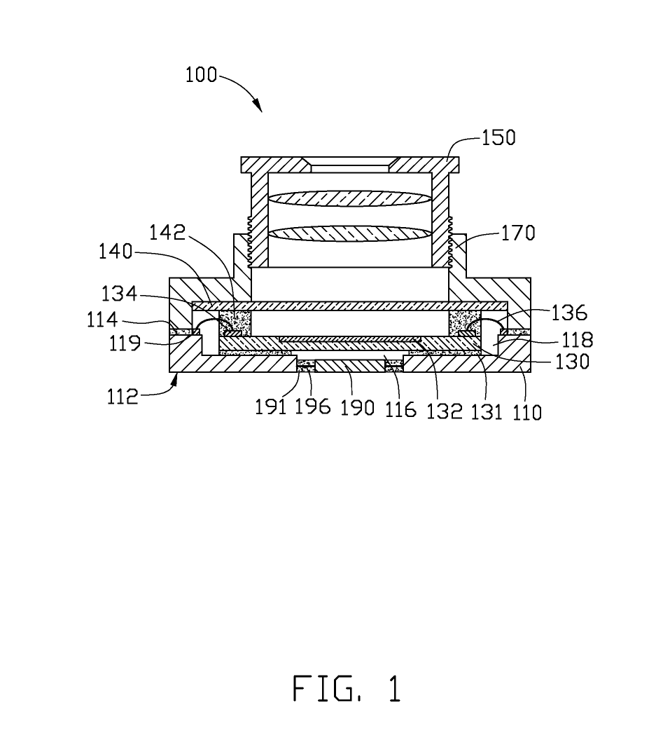

Referring to FIG. 1, an imaging module package 100 in accordance with a present first embodiment is illustrated. The imaging module package 100 comprises a substrate 110, an imaging sensor chip 130, a lens module 150, a housing 170, and a functional unit 190. The imaging sensor chip 130 and the functional unit 190 are received in the substrate 110. The housing 170 is mounted on the substrate 110. The lens module 150 is received in the housing 170.

The substrate 110 comprises a bottom surface 112 and a top surface 114 opposite to the bottom surface 112. The substrate 110 defines a lower chamber 116 extending through the bottom surface 112, and an upper chamber 118 extending through the top surface 114. The lower and upper chambers 116, 118 are communicated and coaxially aligned with each other, and are differently dimensioned. In the embodiment, the upper chamber 118 is larger than the lower chamber 116. The substrate 110 comprises a plurality of soldering pads 119 on the top surface 114.

The imaging sensor chip 130 is mechanically positioned in the upper chamber 118 of the substrate 110 by an adhesive 131. The imaging sensor chip 130 comprises a sensing area 132, and a plurality of soldering pads 134 around the sensing area 132. A plurality of bonding wires 136 connects the soldering pads 134 on the imaging sensor chip 130 to the soldering pads 119 on the substrate 110, respectively, to electrically connect the imaging sensor chip 130 to the substrate 110. A transparent plate 140 is adhered to the imaging sensor chip 130 by an adhesive 142. The adhesive 142 and the transparent plate 140 enclose the sensing area 132 of the imaging sensor chip 130. In the embodiment, the adhesive 142 covers the soldering pads 134 on the imaging sensor chip 130.

The housing 170 with the lens module 150 is mounted on the top surface 114 of the substrate 110 and disposed above the imaging sensor chip 130.

The functional unit 190 is mechanically positioned in the lower chamber 116 of the substrate 110 by an adhesive 191, and electrically connected to the substrate 110 by bonding wires 196. A bottom surface of the functional unit 190 is coplanar with the bottom surface 112 of the substrate 110.

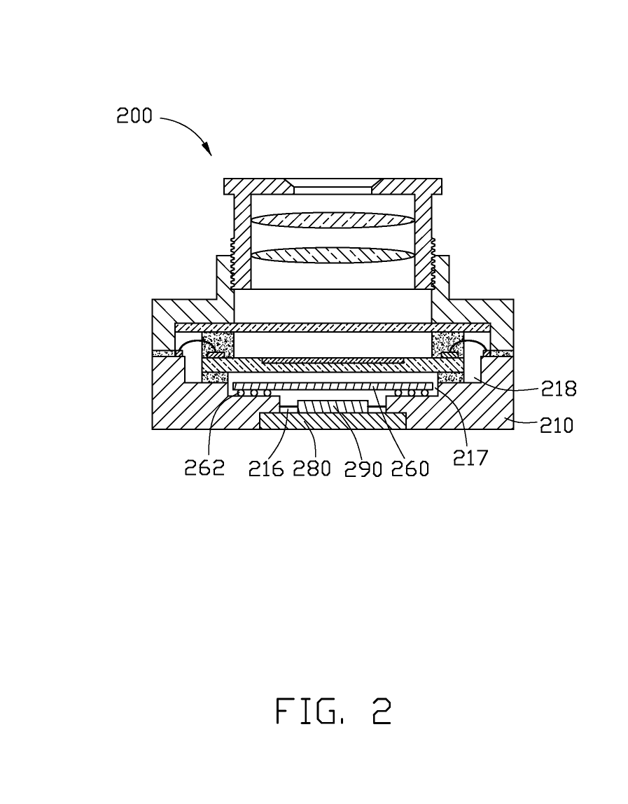

Referring to FIG. 2, an imaging module package 200 according to a present second embodiment is illustrated. The imaging module package 200 is similar to the imaging module package 100. However, a substrate 210 of the imaging module package 200 comprises a lower chamber 216, an upper chamber 218, and an additional chamber 217 between the lower and upper chambers 216, 218. An additional functional unit 260 is received in the additional chamber 217, and electrically connected to the substrate 210 by a plurality of soldering balls 262. A heat dissipating unit 280 is positioned to the substrate 210, for supporting a functional unit 290 positioned in the lower chamber 216 and for removing heat from the functional unit 290. Other features can be referenced from the description of the imaging module package 100 of the first embodiment.

The imaging module packages 100, 200 integrate the functional units 190, 260,290 in the substrates 110, 210, without enlarging volumes of the imaging module packages 100, 200. That is, the imaging module packages 100, 200 are multi-functional and compact.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. An imaging module package comprising:
a substrate defining an upper chamber extending through a top surface thereof, and a lower chamber extending through a bottom surface thereof;
an imaging sensor chip positioned in the upper chamber and electrically connected to the substrate;
a functional unit positioned in the lower chamber and electrically connected to the substrate;
a housing mounted on the top surface of the substrate and disposed above the imaging sensor chip; and
a lens module positioned in the housing.

2. The imaging module package as claimed in claim 1, wherein the upper chamber and the lower chamber are communicated and coaxially aligned with each other.

3. The imaging module package as claimed in claim 2, wherein the substrate defines an additional chamber between the upper chamber and the lower chamber, and an additional functional unit is received in the additional chamber and is electrically connected to the substrate by soldering balls.

4. The imaging module package as claimed in claim 2, wherein the upper chamber is larger than the lower chamber.

5. The imaging module package as claimed in claim 1, wherein a heat dissipating unit is positioned to the substrate, for supporting the functional unit and removing heat from the functional unit.

6. The imaging module package as claimed in claim 1, wherein the imaging sensor chip comprises a sensing area, and a transparent plate is mounted to the imaging sensor chip by an adhesive, and the adhesive and the transparent plate cooperatively enclose the sensing area of the imaging sensor chip.

7. The imaging module package as claimed in claim 1, wherein the imaging sensor chip is mechanically connected to the substrate by an adhesive.

8. The imaging module package as claimed in claim 7, wherein the imaging sensor chip comprises a plurality of soldering pads thereon around the sensing area, and the substrate forms a plurality of soldering pads on the top surface thereof, and bonding wires connect the soldering pads on the imaging sensor chip to the soldering pads on the substrate, respectively, to electrically connect the imaging sensor chip to the substrate.

9. The imaging module package as claimed in claim 8, wherein the adhesive between the transparent plate and the imaging sensor chip covers the soldering pads on the imaging sensor chip.

10. The imaging module package as claimed in claim 1, wherein the functional unit is mechanically connected to the substrate by an adhesive, and electrically connected to the substrate by bonding wires.

11. The imaging module package as claimed in claim 1, wherein a bottom surface of the functional unit is coplanar with or higher than the bottom surface of the substrate.
